(19) United States
(12) Patent Application Publication
(10) Pub. No.: US 2002/0190950 A1
(43) Pub. Date: Dec. 19, 2002

(54) Wireless mouse receiver device

(75) Inventor: Canny Wang, Taipei (TW)

Correspondence Address: DOUGHERTY & TROXELL, SUITE 1404, 5205 LEESBURG PIKE, FALLS CHURCH, VA, 22041, US

(73) Assignee: PATEN Technology Coporation

(21) Appl. No.: 09/880,968

(22) Filed: Jun. 15, 2001

(51) Int. Cl. G09G 5/08

(52) U.S. Cl. 345/163

(57) ABSTRACT

A Wireless Mouse Receiver Device, which comprising: an upper shell body, a lower shell body and an interior structure. The interior of upper shell body has several connection holes. The interior of lower shell body has several connection pillars. And, the interior structure, arranged between the upper shell body and lower body, includes: a connection head, which may be connected to the needed apparatus, a first electric board, on which is arranged with connection head and has several first welding points, and a second electric board, which has several second welding points and comprising: several plane elements, which has several short connection legs that is close to the second electric board, several elevated elements that has several long connection legs welded onto the second electric board and is above the plane element. Wherein, the first electric board is perpendicular to the second electric board and both are welded together by welding points to transmit signal. After the electric boards are welded together, left and right two sides of the first electric board are sandwiched into the outer-radius structure of connection holes in the front portion of the upper shell body, and the connection pillars of the lower shell body are inserted into the connection holes of the upper shell body.

Field of the Invention

The present invention relates to A Wireless Mouse Receiver Device, especially to a kind of miniaturization and connecting a connection head to a receiver to form one body.

### BACKGROUND OF THE INVENTION

The wireless mouse receiver 3 device of the prior art is as shown in FIG. 1. The receiver 3 is connected with a transmission line 31, on which a connection head 341 is arranged, and the connection head 341 is connected with the needed apparatus.

Its shortcomings are:

First, the size of the receiver 3 is big. The original design is applied to the desktop computer and with less restraint of room. But in the application of laptop computer, the design appears that the size of receiver 3 relative to the laptop computer is too big.

Second, a transmission line 31 exists between the receiver 3 and apparatus, when the laptop computer is in application, the existence of the transmission line 31 becomes a redundant line material.

In summarizing above first and second shortcomings, for wireless mouse 2 applied to portable laptop computer 1, although its name is a wireless apparatus, but it has not fulfilled the functions of small size and easy acceptance.

### SUMMARY OF THE INVENTION

The main object of the present invention is to provide a kind of miniaturization and connecting a connection head to a receiver to form one body.

To fulfill above-said object, The Wireless Mouse Receiver Device, which includes: an upper shell body, a lower shell body and an interior structure.

The interior of upper shell body has several connection holes, which are arranged on the front, middle, and rear portion of the interior of upper shell body in two-by-two pairs.

The interior of lower shell body has several connection pillars, which are arranged on the front, middle, and rear portion of the interior of lower shell body in two-by-two pairs. And,

the interior structure, arranged between the upper shell body and lower shell body, includes: A connection head, which may be connected to the needed apparatus.

A first electric board, on which is arranged with the connection head and has several first welding points that are arranged to the rear sides of lower portion of the first electric board.

A second electric board, which has several second welding points that are arranged to the lower sides of front portion of the second electric board and includes:

Several plane elements, which have several short connection legs that are close to the second electric board.

Several elevated elements that have several long connection legs welded onto the second electric board and are above the plane element.

Wherein, the first electric board is perpendicular to the second electric board and both are welded together by welding points to transmit signal. After the first electric board and the second electric board are welded together, left and right two sides of the first electric board are sandwiched into the outer-radius structure of connection holes in the front portion of the upper shell body, and the connection pillars of the lower shell body are inserted into the connection holes of the upper shell body.

To clearly describe the operation principle of the wireless mouse receiver structure applied by the present invention, a detailed description in accordance with several drawings are presented as following:

### BRIEF DESCRIPTION OF THE DRAWINGS

FIG. 1 is an application illustration of the wireless mouse receiver device of the prior art.

FIG. 2 is an application illustration of the wireless mouse receiver device.

FIG. 3A is a front view of the upper shell body of the wireless mouse receiver device.

FIG. 3B is a front view of the interior structure of the wireless mouse receiver device.

FIG. 3C is a front view of the lower shell body of the wireless mouse receiver device.

FIG. 4A is a side view of the upper shell body of the wireless mouse receiver device.

FIG. 4B is a side view of the interior structure of the wireless mouse receiver device n.

FIG. 4C is a side view of the lower shell body of the wireless mouse receiver device.

FIG. 5A is a top view of the upper shell body of the wireless mouse receiver device.

FIG. 5B is a top view of the interior structure of the wireless mouse receiver device.

FIG. 5C is a top view of the lower shell body of the wireless mouse receiver device.

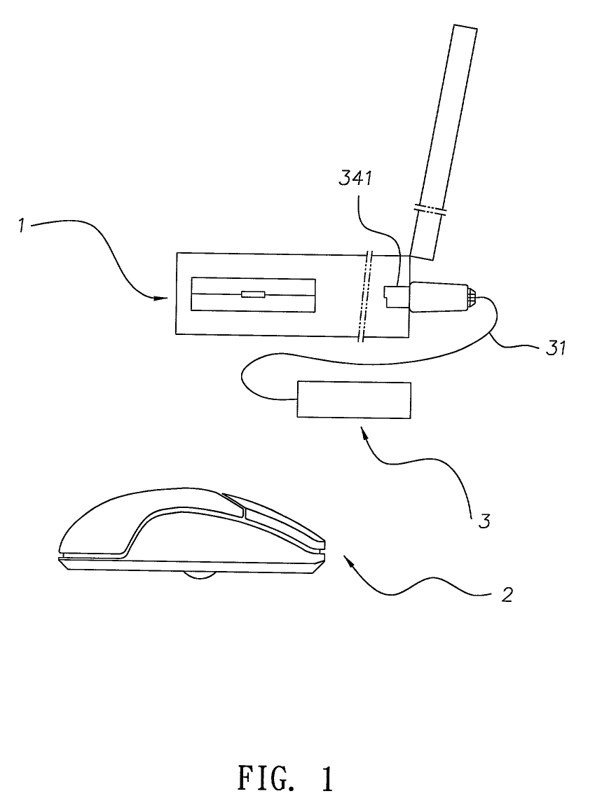

### DESCRIPTION OF THE PREFERRED EMBODIMENTS

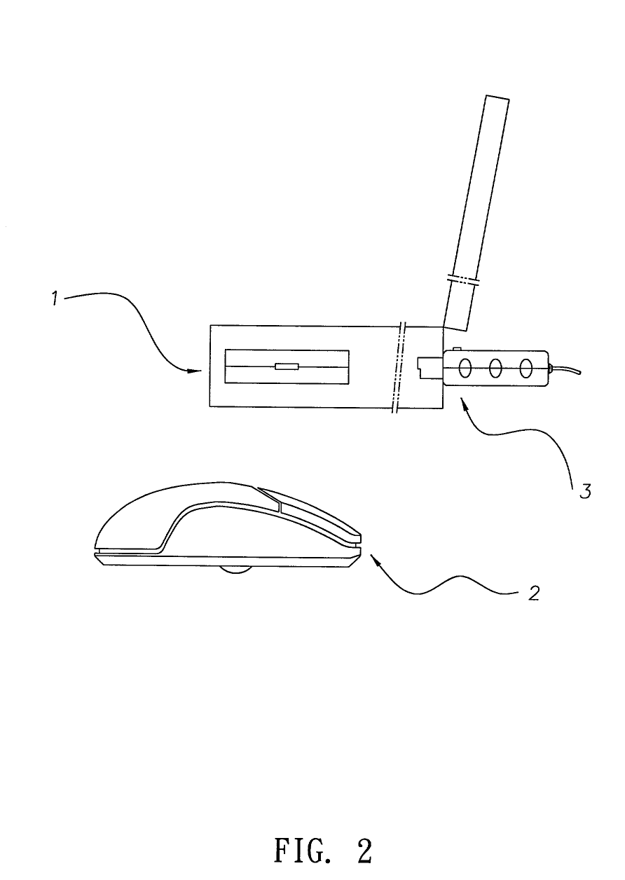

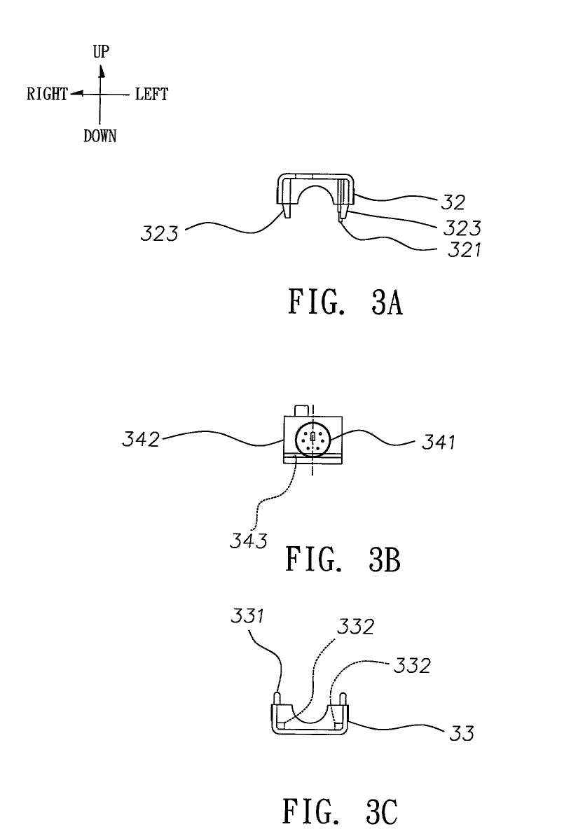

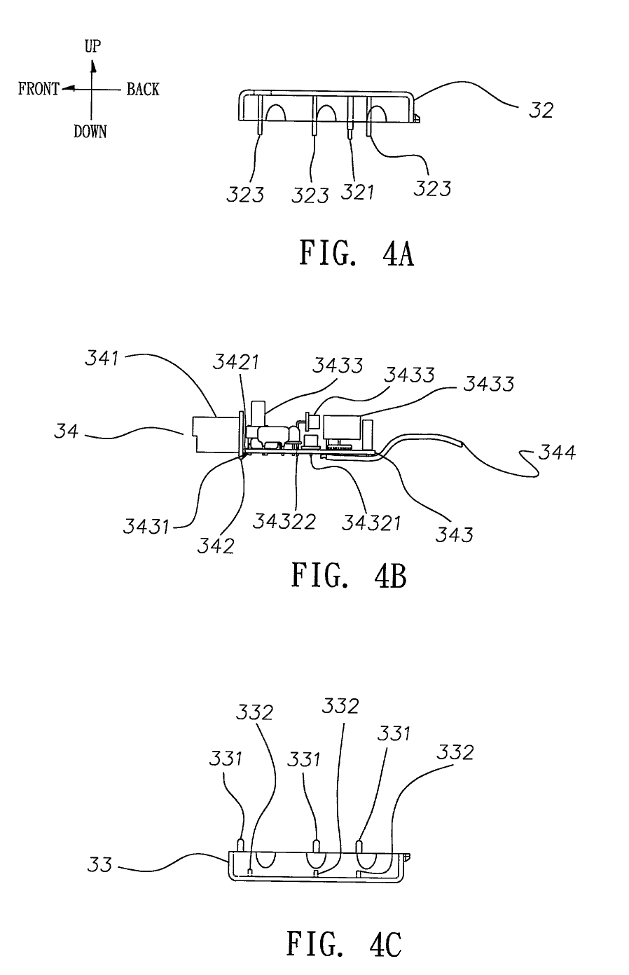

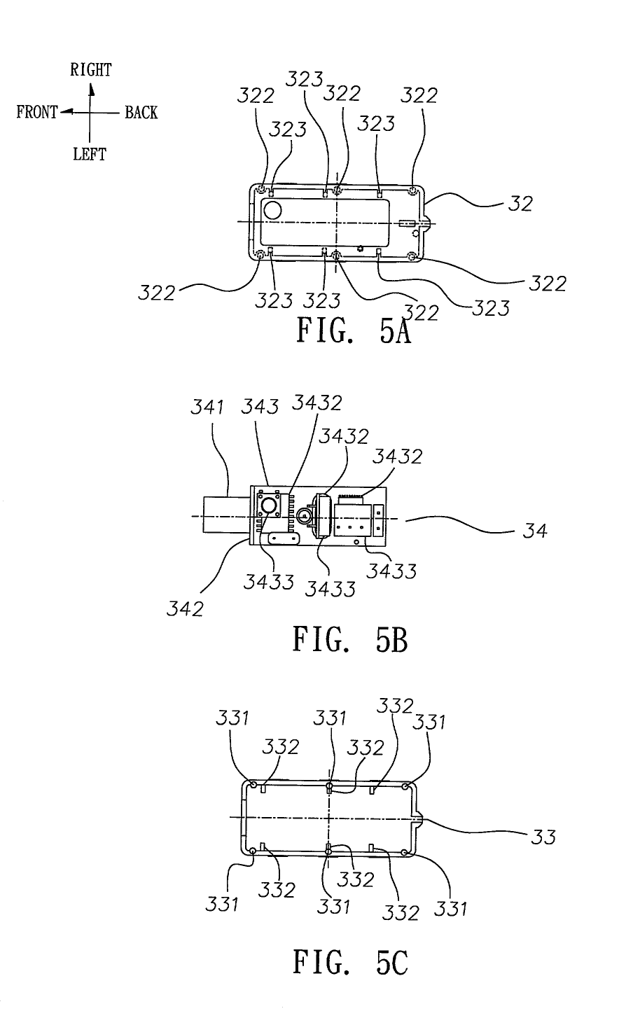

FIG. 2 is a preferable embodiment of the present invention. Following is the constitution description of the present invention. Please refer to FIG. 3 through FIG. 5:

A wireless mouse receiver 3 device, which includes: an upper shell body 32, a lower shell body 33 and an interior structure 34.

The interior of upper shell body 32 has several connection holes 322, which are arranged on the front, middle, and rear portion of the interior of upper shell body 32 in two-by-two pairs.

The interior of lower shell body 33 has several connection pillars 331, which are arranged on the front, middle, and rear portion of the interior of lower shell body 33 in two-by-two pairs. And,

the interior structure 34, arranged between the upper shell body 32 and lower shell body 33, includes:

A connection head 341, which may be connected to the needed apparatus.

A first electric board 342, on which is arranged with the connection head 341 and has several first welding points 3421 that are arranged to the rear sides of lower portion of the first electric board 342.

A second electric board 343, which has several second welding points 3431 that are arranged to the front sides of lower portion of the second electric board 343 and includes:

Several plane elements 3432, which have several short connection legs 34321 that are close to the second electric board 343.

Several elevated elements 3433 that have several long connection legs 34322 welded onto the second electric board 343 and are above the plane element 3432.

Wherein, the first electric board 342 is perpendicular to the second electric board 343 and both are welded together by welding points to transmit signal. After the first electric board 342 and the second electric board 343 are welded together, left and right two sides of the first electric board 322, are sandwiched into the outer-radius structure of connection holes 322 in the front portion of the upper shell body 32, and the connection pillars 331 of the lower shell body 33 are inserted into the connection holes 322 of the upper shell body 32.

Preferably, the upper shell body 32 further has an orientation pillar 321, and the second electric board 343 has an orientation hole 3434. When the orientation hole 3434 makes the interior structure arranged into the upper shell body 32, the rear biased displacement is guided and corrected by the orientation pillar 321.

Preferably, the lower shell body 33 further has several padding blocks 332, which are two-by-two in pairs arranged to the front, middle, and rear portion of the interior of the lower shell body 33. The upper shell body 32 further has several pushing pillar 323, which are two-by-two in pairs arranged to the front, middle, and rear portion of the interior of the upper shell body 32. The padding block 332 and pushing pillar 323 fix the upper and lower positions of its interior structure 34.

Preferably, the second electric board 343 is connected to an antenna 344 that is exposed to the outside of the shell body.

Preferably, the antenna 344 may also be a hidden type antenna 344.

In summarizing above description, the present invention upwardly arranges the electric elements in series with a plural layer structure to make a same electric board area may install more elements on itself and get a most light and clever design by reducing the entire size of the receiver 3. Furthermore, the plural electric boards are welded with vertical manner, which is also a witty and subtle thought of present invention and means to create the most efficient combination within a limited space. Nonetheless, with the witty and subtle combination of the interior structure 34 and the shell body, a structure of high strength is created to make the present invention form a size of plug-likewise and indeed has the function of a wireless receiver.

What is claimed is:

1. A Wireless Mouse Receiver Device, comprising:
an upper shell body, of which the interior has several connection holes that are arranged on the front, middle, and rear portion of the interior of upper shell body in two-by-two pairs;
a lower shell body, of which the interior has several connection pillars that are arranged on the front, middle, and rear portion of the interior of lower shell body in two-by-two pairs; and
an interior structure, arranged between the upper shell body and lower shell body, comprising:
a connection head, which may be connected to the needed apparatus;
a first electric board, on which is arranged with the connection head and has several first welding points that are arranged to the rear sides of lower portion of the first electric board;
a second electric board, which has several second welding points that are arranged to the front sides of lower portion of the second electric board and includes:
several plane elements, which have several short connection legs that are close to the second electric board;
several elevated elements that have several long connection legs welded onto the second electric board and are above the plane element; wherein, the first electric board is perpendicular to the second electric board and both are welded together by welding points to transmit signal; after the first electric board and the second electric board are welded together, left and right two sides of the first electric board are sandwiched into the outer-radius structure of connection holes in the front portion of the upper shell body, and the connection pillars of the lower shell body are inserted into the connection holes of the upper shell body.

2. The Wireless Mouse Receiver Device of the claim 1, wherein the upper shell body further has an orientation pillar, and the second electric board has an orientation hole; when the orientation hole makes the interior structure arranged into the upper shell body, the rear biased displacement is guided and corrected by the orientation pillar.

3. The Wireless Mouse Receiver Device of the claim 1, wherein the lower shell body further has several padding blocks, which are two-by-two in pairs arranged to the front, middle, and rear portion of the interior of the lower shell body; the upper shell body further has several pushing pillar, which are two-by-two in pairs arranged to the front, middle, and rear portion of the interior of the upper shell body. The padding block and pushing pillar fix the upper and lower positions of its interior structure.

4. The Wireless Mouse Receiver Device of the claim 1, wherein the second electric board is connected to an antenna that is exposed to the outside of the shell body.

5. The Wireless Mouse Receiver Device of the claim 4,wherein the antenna may also be a hidden type antenna.
